(19) United States
(12) Patent Application Publication
(10) Pub. No.: US 2023/0068472 A1
(43) Pub. Date: Mar. 2, 2023

(54) DRIVING ASSISTANCE APPARATUS, VEHICLE, DRIVING CONTROL METHOD, AND PROGRAM

(71) Applicant: TOYOTA JIDOSHA KABUSHIKI KAISHA, Toyota-shi (JP)

(72) Inventor: Yuki KAWASAKI, Mishima-shi (JP)

(73) Assignee: TOYOTA JIDOSHA KABUSHIKI KAISHA, Toyota-shi (JP)

(21) Appl. No.: 17/881,141

(22) Filed: Aug. 4, 2022

(30) Foreign Application Priority Data
Aug. 27, 2021 (JP) 2021-138706

(51) Int. Cl. B60W 30/16; B60W 30/14; B60W 40/105; G06V 20/58

(52) U.S. Cl. CPC B60W 30/16; B60W 30/143; B60W 40/105; G06V 20/584; B60W 2420/42; B60W 2554/4023; B60W 2554/80; B60W 2555/60

(57) ABSTRACT

The driving assistance apparatus comprises a camera device configured to obtain a camera image by taking a picture of a predetermined area ahead of a host vehicle; and a control unit configured to drive the host vehicle so as to cause an acceleration of the host vehicle to become equal to a follow-up acceleration to make an inter vehicle distance to a preceding vehicle coincide with a target inter vehicle distance. When the preceding vehicle is a large-size vehicle, the control unit obtains the target inter vehicle distance for causing a traffic-signal-equipment-distance indicative of a distance to a traffic signal equipment of when the traffic signal equipment is detected above the preceding vehicle in the camera image to be longer than a stop-required-distance for which the host vehicle travels until the host vehicle stops under the assumption that the host vehicle decelerates at a predetermined deceleration.

### TECHNICAL FIELD

The present disclosure relates to a driving assistance apparatus configured to perform a follow-up cruise control, which is a form of autonomous driving, to drive a host vehicle in such a manner that an inter vehicle distance (or following distance) between a preceding vehicle traveling in front (or ahead) of the host vehicle and the host vehicle becomes equal to (or coincides with) a target inter vehicle distance.

### BACKGROUND

There has been a known driving assistance apparatus configured to perform the follow-up cruise control.

For example, one (hereinafter, referred to as a “first conventional apparatus”) of the driving assistance apparatuses, disclosed in Japanese Patent Application Laid-Open No. 2009-149167, is configured to perform a deceleration control to decelerate the host vehicle at an appropriate deceleration that agrees with feeling of a driver of the host vehicle in order to maintain the inter vehicle distance between the preceding vehicle and the host vehicle at a distance longer than a final target distance.

Another (hereinafter, referred to as a “second conventional apparatus”) of the driving assistance apparatuses, disclosed in Japanese Patent Application Laid-Open No. 2011-154619, is configured to perform a deceleration control so as to stop the host vehicle at or before a traffic signal equipment showing (indicating) a stop signal.

### SUMMARY

Here, it is assumed that the second conventional apparatus performs the follow-up cruise control similarly to the first conventional apparatus. When the preceding vehicle is a large-size vehicle, such as a truck, and a bus, a traffic signal equipment (i.e. traffic lights) may be hidden by the preceding vehicle. This may cause the second conventional apparatus to perform a deceleration control that decelerates the host vehicle at a large deceleration, since a distance between the traffic signal equipment and the host vehicle is short when the second conventional apparatus successfully detects the traffic signal equipment for the first time. Such a deceleration control that decelerates the host vehicle at the large deceleration may cause the driver of the host vehicle feel uneasy.

The present disclosure has been made to cope with the problem described above. One of the objectives of the present disclosure is to provide a driving assistance apparatus that is capable of preventing the host vehicle from being decelerated at a large deceleration that may cause passengers/occupants of the host vehicle to feel uneasy when causing the host vehicle to stop at or before the traffic signal equipment showing a stop signal.

A driving assistance apparatus (hereinafter, referred to as a “present disclosure apparatus”) according to the present disclosure comprises:

a camera device (22) configured to obtain a camera image by taking a picture of a predetermined area ahead of a host vehicle; and

a control unit (20, 30, 36, 40, 44) configured to drive the host vehicle so as to cause an acceleration of the host vehicle to become equal to a follow-up acceleration to make an inter vehicle distance between a preceding vehicle traveling ahead of the host vehicle and the host vehicle coincide with a target inter vehicle distance.

The control unit is configured to:
when the preceding vehicle is a large-size vehicle (“Yes” at step 510), set the target inter vehicle distance to a large-size-vehicle inter vehicle distance (step 530), wherein the large-size-vehicle inter vehicle distance is a distance for causing a traffic-signal-equipment-distance indicative of a distance to a traffic signal equipment having a predetermined height of a detection time point at which the traffic signal equipment is detected above the preceding vehicle in the camera image to be longer than a stop-required-distance indicative of a distance for which the host vehicle travels (or is required to run) until the host vehicle stops assuming (under the assumption) that the host vehicle starts decelerating at a predetermined deceleration from said detection time point; and
drive the host vehicle so as to cause an acceleration of the host vehicle to become equal to the follow-up acceleration (step 455).

The traffic-signal-equipment-distance indicative of a distance to the traffic-signal equipment (i.e., a distance between the host vehicle and the traffic-signal equipment) of when the traffic-signal equipment is detected above the preceding vehicle in the camera image is longer as the inter vehicle distance to the preceding vehicle in a case where the preceding vehicle is the large-size vehicle is longer. According to the present disclosure apparatus, when the preceding vehicle is the large-size vehicle, the target inter vehicle distance is set to the large-size-vehicle inter vehicle distance that can cause the traffic-signal-equipment-distance of when the traffic-signal equipment is detected above the preceding vehicle in the camera image to be longer than the stop-required-distance, and the host vehicle is caused to travel in such a manner that the inter vehicle distance is maintained at the target inter vehicle distance. Therefore, if the host vehicle is decelerated at the predetermined deceleration when and after the traffic signal equipment showing a stop signal is detected, the host vehicle can be stopped at or before the traffic signal equipment showing a stop signal. This can prevent the host vehicle from being decelerated at a large deceleration that may cause the passengers/occupants of the host vehicle to feel uneasy, in order for the host vehicle to be stopped at (before) the traffic signal equipment showing the stop signal.

In some embodiments of the present disclosure,
the control unit is configured to obtain the target inter vehicle distance in such a manner that the target inter vehicle distance for a case where the preceding vehicle is a large-size vehicle is longer than (the target inter vehicle distance) for a case where the preceding vehicle is not a large-size vehicle, when a host vehicle speed indicative of a speed of the host vehicle is equal to or higher than a predetermined speed (Vsd) (refer to FIG. 3).

As described above, when the preceding vehicle is a large size vehicle, the target inter vehicle distance is set to a distance that can cause the traffic-signal-equipment-distance to be longer than the stop-required-distance. Meanwhile, the stop-required-distance is longer as the host vehicle speed is higher (i.e., the stop-required-distance is shorter as the host vehicle speed is lower). Therefore, the target inter vehicle distance for the case where the preceding vehicle is a large size vehicle is longer (or is preferably set to be longer) than the target inter vehicle distance for the case where the preceding vehicle is not a large size vehicle, when the host vehicle speed is equal to or higher than the predetermined speed.

In some embodiments of the present disclosure,
the control unit is configured to:
   set, when the preceding vehicle is not a large-size vehicle (“No” at step 510), the target inter vehicle distance to an ordinary inter vehicle distance that is longer within a predetermined range from a preset inter vehicle distance as the host vehicle speed is higher (step 515); and
   set, when the preceding vehicle is a large-size vehicle (“Yes” at step 510), the target inter vehicle distance to either the ordinary inter vehicle distance or the large-size-vehicle inter vehicle distance, whichever is longer (step 535 to step 545).

This can prevent the host vehicle from approaching the preceding vehicle too closely when the host vehicle speed is lower than the predetermined speed, and therefore, can decrease a possibility to cause the passenger(s) of the host vehicle to feel uneasy.

In some embodiments of the present disclosure, the control unit is configured to obtain the large-size-vehicle inter vehicle distance in such a manner that the large-size-vehicle inter vehicle distance is equal to or longer than a distance obtained by multiplying the stop-required-distance by a preset constant (step 530, expression (4)).

In addition, the preset constant has been set at a value obtained by dividing a first value (H2) by a second value (H1), wherein the first value (H2) is a value obtained by subtracting a preset camera height (Hca) indicative of a height of the camera device from a preset large-size vehicle height (Hlv) indicative of a (typical) height of the large-size vehicle, and the second value (H1) is a value obtained by subtracting the camera height (Hca) from a preset traffic-signal height (Htr) indicative of a (typical) height of the traffic signal equipment (expression (4)).

According to the above embodiment, the large-size-vehicle inter vehicle distance can be obtained in such a manner that the traffic-signal-equipment-distance of when the traffic signal equipment is detected above the preceding vehicle is assured to be longer than the stop-required-distance. This can decrease a possibility that the host vehicle needs to be decelerated at a large deceleration in order for the host vehicle to be stopped at or before the traffic signal equipment showing a stop signal. Hereinafter, the situation that the host vehicle needs to be decelerated at a large deceleration may be referred to as an “emergent deceleration situation”.

In the above embodiment, the control unit is configured to obtain the large-size-vehicle inter vehicle distance in such a manner that the large-size-vehicle inter vehicle distance varies depending on a square of a host vehicle speed indicative of a speed of the host vehicle so that the said large-size-vehicle inter vehicle distance becomes longer as the host vehicle speed becomes higher (step 530, expression (4), and FIG. 3).

As described above, the large-size-vehicle inter vehicle distance is set to a value that is equal to or longer than the distance obtained by multiplying the stop-required-distance by the constant. The stop-required-distance is a value that varies depending on a square of the host vehicle speed so that stop-required-distance becomes longer as the host vehicle speed becomes higher, as in the expression (3) described later. Therefore, the large-size-vehicle inter vehicle distance varies similarly to the stop-required-distance. According to the above embodiment, the large-size-vehicle inter vehicle distance can be obtained in such a manner that the traffic-signal-equipment-distance of when the traffic signal equipment is detected above the preceding vehicle is assured to be longer than the stop-required-distance. Thus, the possibility that the emergent deceleration situation occurs can be reduced.

In some embodiments of the present disclosure,

the control unit is configured to drive the host vehicle so as to make an acceleration of the host vehicle coincide with either the follow-up acceleration or a deceleration that causes the host vehicle to stop before the traffic signal equipment, whichever is smaller (step 445, step 450, step 475), when the traffic-signal-equipment-distance becomes equal to or shorter than a start distance that is a sum of the stop-required-distance and a predetermined distance while the traffic signal equipment is showing a stop signal (“Yes” at step 465).

According to this embodiment, when the traffic-signal-equipment-distance becomes equal to or shorter than the start distance, the host vehicle is driven in such a manner that the acceleration of the host vehicle coincides with either the follow-up acceleration or the above-described deceleration, whichever is smaller. This can let the host vehicle stop before the traffic signal equipment showing a stop signal. In addition, even when the preceding vehicle is decelerating rapidly before the traffic signal equipment showing a stop signal, the host vehicle can be decelerated with/while keeping the inter vehicle distance to the preceding vehicle at the target inter vehicle distance.

In some embodiments of the present disclosure,

the control unit is configured to:
when the preceding vehicle is not the large-size vehicle (“No” at step 510),
   obtain, as the target inter vehicle distance, an ordinary inter vehicle distance that becomes longer as a host vehicle speed indicative of a speed of the host vehicle becomes higher within a predetermined range from a preset inter vehicle distance (step 505, step 515); and
when a vehicle, that is other than the preceding vehicle, that is present within a predetermined distance in a forward direction from the host vehicle is the large-size vehicle (“Yes” at step 705),
   obtain the ordinary inter vehicle distance and the large-size-vehicle inter vehicle distance (step 505, step 710);
   set the target inter vehicle distance to the ordinary inter vehicle distance (step 515), when a first distance deviation is smaller than a second distance deviation (“Yes” at step 725), wherein the first distance deviation is a value obtained by subtracting the ordinary inter vehicle distance from the inter vehicle distance, and the second distance deviation is a value obtained by subtracting the large-size-vehicle inter vehicle distance from an inter vehicle distance between the large-size vehicle and the host vehicle; and
   set the target inter vehicle distance to the large-size-vehicle inter vehicle distance (step 730), when the first distance deviation is equal to or greater than the second distance deviation (“No” at step 725).

According to this embodiment, when the vehicle other than the preceding vehicle is the large-size vehicle, the host vehicle can be driven while keeping the inter vehicle distance (to the preceding vehicle) at a distance in such a manner that the traffic-signal-equipment-distance of when the traffic signal equipment is detected above the large-size vehicle that is the vehicle other than the preceding vehicle in the camera image is longer than the stop-required-distance. Therefore, this can decrease a possibility that the emergent deceleration situation occurs.

The present disclosure apparatus is installed in the vehicle (host vehicle).

A driving control method according to the present disclosure is a method for driving a host vehicle in such a manner that an acceleration of the host vehicle is caused to become equal to a follow-up acceleration to make an inter vehicle distance between a preceding vehicle traveling ahead of the host vehicle and the host vehicle coincide with a target inter vehicle distance, comprising:

a first step for setting the target inter vehicle distance to a large-size-vehicle inter vehicle distance (step 530) when the preceding vehicle is a large-size vehicle (“Yes” at step 510), the large-size-vehicle inter vehicle distance for causing a traffic-signal-equipment-distance indicative of a distance to a traffic signal equipment having a predetermined height of a detection time point at which the traffic signal equipment is detected above the preceding vehicle in a camera image obtained by a camera device (22) mounted on the host vehicle by taking a picture of a predetermined area ahead of the host vehicle to be longer than a stop-required-distance indicative of a distance for which the host vehicle travels until the host vehicle stops assuming that (or under the assumption that) the host vehicle starts decelerating at a predetermined deceleration from the detection time point; and

a second step for driving the host vehicle in such a manner that the acceleration of the host vehicle coincides with the follow-up acceleration (step 455).

A program storage device, readable by machine, according to the present disclosure, storing a program for driving a host vehicle in such a manner that an acceleration of said host vehicle is caused to become equal to a follow-up acceleration to make an inter vehicle distance between a preceding vehicle traveling ahead of said host vehicle and said host vehicle coincide with a target inter vehicle distance,

said program causing a processor to implement processes of:

a first step for setting the target inter vehicle distance to a large-size-vehicle inter vehicle distance (step 530) when the preceding vehicle is a large-size vehicle (“Yes” at step 510), the large-size-vehicle inter vehicle distance for causing a traffic-signal-equipment-distance indicative of a distance to a traffic signal equipment having a predetermined height of a detection time point at which the traffic signal equipment is detected above the preceding vehicle in a camera image obtained by a camera device (22) mounted on the host vehicle by taking a picture of a predetermined area ahead of the host vehicle to be longer than a stop-required-distance indicative of a distance for which the host vehicle travels until the host vehicle stops assuming that (or under the assumption that) the host vehicle starts decelerating at a predetermined deceleration from the said detection time point; and

a second step for driving the host vehicle in such a manner that the acceleration of the host vehicle coincides with the follow-up acceleration (step 455).

According to the above-described driving control method and the above-described program, when and after the traffic signal equipment showing a stop signal is detected, the host vehicle can be stopped at or before the traffic signal equipment showing a stop signal by decelerating the host vehicle at the predetermined deceleration. This can prevent the host vehicle from being decelerated at a large deceleration that may cause the passengers/occupants of the host vehicle to feel uneasy, in order for the host vehicle to be stopped at (before) the traffic signal equipment showing the stop signal.

The present disclosure apparatus can be expressed as follows.

The present disclosure apparatus comprises:

a camera device (22) configured to obtain a camera image by taking a picture of a predetermined area ahead of a host vehicle; and

a control unit (20, 30, 36, 40, 44) configured to drive the host vehicle so as to make an inter vehicle distance between a preceding vehicle traveling ahead of the host vehicle and the host vehicle coincide with a target inter vehicle distance,

wherein,

the control unit is configured to make (let) the target inter vehicle distance of when the preceding vehicle is a large-size vehicle (be) larger than the target inter vehicle distance of when the preceding vehicle is not a large-size vehicle, in a case where a host vehicle speed indicative of a speed of the host vehicle is equal to or higher than a predetermined speed (Vsd).

Notably, in the above description, in order to facilitate understanding of the present disclosure, the constituent elements or the like of the disclosure corresponding to those of the embodiments of the disclosure which will be described later are accompanied by parenthesized names and/or symbols which are used in the embodiments. However, the constituent elements of the disclosure should not be limited to those in the embodiments defined by the names and/or the symbols.

### BRIEF DESCRIPTION OF THE DRAWINGS

FIG. 1 is a schematic system diagram of a driving assistance apparatus according to an embodiment of the present disclosure.

FIG. 2 is a drawing for describing a second inter vehicle distance obtained when a preceding vehicle is a large-size vehicle.

FIG. 3 is a graph indicating a relationship between a first inter vehicle distance and a host vehicle speed, and a relationship between the second inter vehicle distance and the host vehicle speed.

FIG. 4 is a flowchart illustrating an ACC routine executed by a CPU of a driving assistance ECU shown in FIG. 1.

FIG. 5 is a flowchart illustrating a follow-up acceleration obtaining subroutine executed by the CPU of the driving assistance ECU shown in FIG. 1.

FIG. 6 is a drawing for describing an outline of a first modification of the embodiment according to the present disclosure.

FIG. 7 is a flowchart illustrating a part of a follow-up acceleration obtaining subroutine executed by a CPU included in a driving assistance ECU of the first modification of the embodiment according to the present disclosure.

### DETAILED DESCRIPTION

### (Configuration)

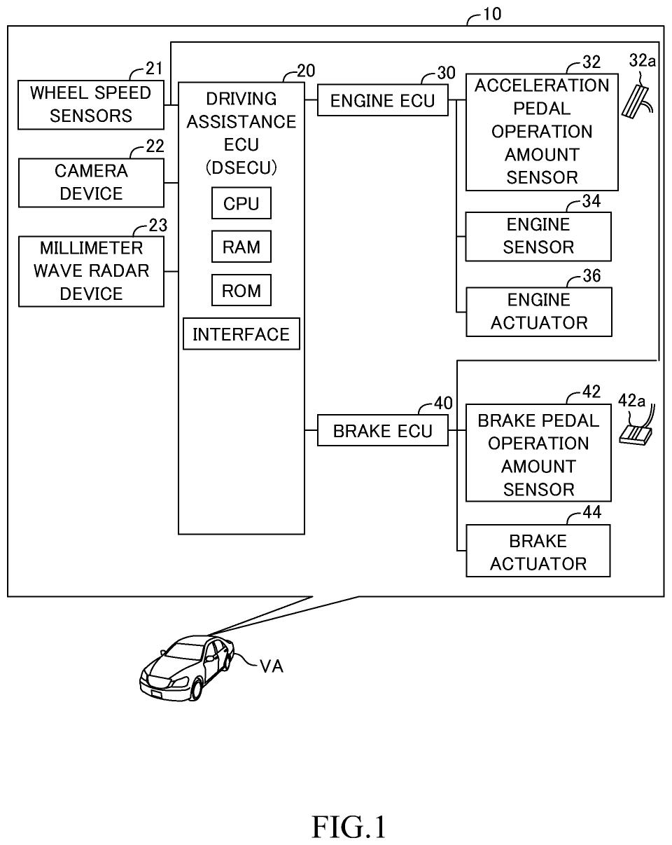

As shown in FIG. 1, a driving assistance apparatus (hereinafter, referred to as a “present assistance apparatus”) 10 according to an embodiment of the present disclosure is applied to (or installed in) a vehicle (hereinafter, referred to as a “host vehicle”) VA.

The present assistance apparatus 10 comprises a driving assistance/support ECU 20, an engine ECU 30, and a brake ECU 40. Hereinafter, the driving assistance ECU 20 is referred to as a “DSECU 20”.

Each of these ECUs is a control unit (i.e., an Electronic Control Unit) that is sometimes referred to as a “controller” or a “computer”, and includes a microcomputer as a main component. The microcomputer includes a CPU, a ROM, a RAM, and an interface (I/F). The ECUs are communicably connected with each other so as to be able to mutually exchange data through a CAN (Controller Area Network). The CPU is configured or programmed to realize various functions by executing instructions, programs, or routines stored in the ROM. Some or all of the ECUs may be integrated into a single ECU.

The present assistance apparatus 10 comprises wheel speed sensors 21, a camera device 22, and a millimeter wave radar device 23. They are connected to the DSECU 20 so as to mutually exchange data therebetween.

The wheel speed sensors 21 are provided to respective wheels of the host vehicle VA. Each of the wheel speed sensors 21 generates one wheel pulse signal when the corresponding wheel rotates by a predetermined angle. The DSECU 20 counts the number of the wheel pulse signals from each of the wheel speed sensors 21 per unit time, and obtains a wheel rotational speed (or a wheel speed) of each of the wheels based on the counted number. The DSECU 20 obtains a host vehicle speed Vs indicative of a moving speed of the host vehicle VA based on the wheel rotational speeds of the wheels. For instance, the DSECU 20 obtains an average of the wheel speeds of four of the wheels as the host vehicle speed Vs.

The camera device 22 is arranged at an upper part of a front windshield and at a center of the front windshield, inside a cabin of the host vehicle VA. The camera device 22 is configured to obtain/capture an image (hereinafter, referred to as a “camera image”) of a predetermined area in front of (or ahead of) the host vehicle VA. The camera device 22 is configured to obtain, based on the camera image, object information and white line information, and transmits camera object information including the object information and the white line information to the DSECU 20. The object information includes a distance between an object present in the predetermined area and the host vehicle VA, and a direction/orientation of the object with respect to the host vehicle VA. The white line information includes a position of each of a right white line and a left white line relative to the host vehicle VA. The left white line and the right white line define a lane that is a host-vehicle-traveling-lane in which the host vehicle VA is currently traveling/running.

The millimeter wave radar device 23 is a well-known sensor. The millimeter wave radar device 23 radiates/transmits a millimeter wave to an area ahead of the host vehicle. The millimeter wave radar device 23 receives a millimeter wave that is a reflected wave generated by an object so as to detect the object. The millimeter wave radar device 23 obtains, through calculation based on the received reflected wave, a distance (object distance) to the object, a relative speed (object relative speed) Vr of the object with respect to the host vehicle VA, and a direction of the object. The millimeter wave radar device 23 transmits radar object information to the DSECU 20 every time a predetermined time elapses. The radar object information includes “the object distance, the object relative speed Vr, and the direction of the object”.

The DSECU 20 identifies the position of the object present ahead of (in front of) the host vehicle VA with respect (or relative) to the host vehicle VA, based on the camera object information and the radar object information.

The engine ECU 30 is connected with an acceleration pedal operation amount sensor 32 and an engine sensor 34, and receives detection signals from them.

The acceleration pedal operation amount sensor 32 is configured to detect an operation amount (i.e., an acceleration pedal operation amount AP) of an acceleration pedal 32a of the host vehicle VA. When the driver does not operate the acceleration pedal 32a, the acceleration pedal operation amount AP is “0”.

The engine sensor 34 is for detecting operating state amounts of an unillustrated “internal combustion engine serving as a driving source of the host vehicle VA”. The engine sensor 34 may include a throttle valve opening amount sensor, an engine rotational speed sensor, and an intake air amount sensor.

The engine ECU 30 is further connected with an engine actuator 36 that may be a throttle valve actuator and fuel injectors. The engine ECU 30 is configured to drive the engine actuator 36 to change a torque generated by the internal combustion engine so as to adjust a driving force of the host vehicle VA.

The engine ECU 30 determines a target throttle valve opening TAtgt in such a manner that the target throttle valve opening TAtgt becomes greater as the acceleration pedal operation amount AP becomes greater. The engine ECU 30 drives the throttle valve actuator so as to make a throttle valve opening equal to the target throttle valve opening TAtgt.

The brake ECU 40 is connected with the wheel speed sensors 21 and a brake pedal operation amount sensor 42, and receives detected signals from them.

The brake pedal operation amount sensor 42 is configured to detect an operation amount (i.e., a brake pedal operation amount BP) of a brake pedal 42a of the host vehicle VA. When the driver does not operate the brake pedal 42a, the brake pedal operation amount BP is “0”.

The brake ECU 40 is configured to obtain the host vehicle speed Vs base on the wheel pulse signals from each of the wheel speed sensors 21, similarly to the DSECU 20. The brake ECU 40 may be configured to receive the host vehicle speed Vs from the DSECU 20.

The brake ECU 40 is further connected with a brake actuator 44 that is a hydraulic control actuator. The brake actuator 44 is disposed in an unillustrated hydraulic circuit between an unillustrated master cylinder for pressurizing a hydraulic oil in accordance with a pedal force of the brake pedal 42a and unillustrated well-known friction brake devices including wheel cylinders provided at the respective wheels. The brake actuator 44 can adjust/change a pressure of the hydraulic oil supplied to the wheel cylinders so as to adjust/control a brake force of the host vehicle VA.

The brake ECU 40 determines a target acceleration that is negative, based on the brake pedal operation amount BP. The brake ECU 40 drives the brake actuator 44 so as to make an actual acceleration of the vehicle VA equal to the target acceleration.

### (ACC)

The DSECU 20 is configured to perform/execute an ACC (Adaptive Cruise Control). The ACC includes two kinds of controls. One of them is a constant speed cruise control and the other one of them is a follow-up cruise control.

The constant speed cruise control is performed when a preceding vehicle VB traveling ahead (in front) of the host vehicle VA is not present. The constant speed cruise control is a control to let the host vehicle VA travel/run while maintaining the host vehicle speed Vs at a set speed Vset that has been set/determined by the driver of the host vehicle VA in advance. More specifically, the DSECU 20 drives the vehicle in such a manner that an acceleration G of the host vehicle VA coincides with (becomes equal to) a “target acceleration for making the host vehicle speed Vs coincide with (become equal to) the set speed Vset”.

The follow-up cruise control is performed when the preceding vehicle VB is present. The follow-up cruise control is a control to let the host vehicle VA travel/run while maintaining the inter vehicle distance D between the preceding vehicle VB and the host vehicle VA at a “first inter vehicle distance D1 that is determined to be longer as the host vehicle speed Vs is higher within a predetermined range that includes a set inter vehicle distance Dset”, for the host vehicle VA to follow up the preceding vehicle VB. More specifically, the DSECU 20 drives the host vehicle VA in such a manner that the acceleration G coincides with (becomes equal to) a “target acceleration for maintaining the inter vehicle distance D at the first inter vehicle distance D1”. The first inter vehicle distance D1 may sometimes be referred to as an “ordinary (or normal) inter vehicle distance”.

The target acceleration used in each of the constant speed cruise control and the follow-up cruise control is referred to as an “ACC target acceleration Gacc”.

When the constant speed cruise control or the follow-up cruise control is being performed, the host vehicle VA travels without requiring driver's operations of any of the acceleration pedal 32a and the brake pedal 42a.

While the DSECU 20 is performing the ACC, the DSECU 20 continues determining whether or not a traffic signal equipment showing a stop signal TR is present ahead (in front) of the host vehicle VA, based on the camera image. The traffic signal equipment showing a stop signal TR is a traffic light showing a stop signal, and may be a traffic signal equipment showing a red light or a yellow light.

When the DSECU 20 determines that the “traffic signal equipment showing a stop signal TR” is present, and that a traffic-signal-equipment-distance Dtr to “that traffic signal equipment showing a stop signal TR” is equal to or shorter than a “start distance Ds described later”, the DSECU 20 obtains (reads out from the ROM) a predetermined deceleration Gdec as a target stop-acceleration (or a target acceleration for stopping) Gtr. Thereafter, the DSECU 20 drives the host vehicle VA in such a manner that the acceleration G coincides with (becomes equal to) “the ACC target acceleration Gacc or the target stop-acceleration Gtr, whichever smaller”. This causes the host vehicle VA to stop at (before) the traffic signal equipment showing a stop signal TR.

The deceleration Gdec has been set at a deceleration (e.g., −2.0 m/s2) that is unlikely to cause the passengers of the host-vehicle VA to feel uneasy.

The start distance Ds is a distance obtained by adding a predetermined distance Dp to a stop-required-distance Dn. The stop-required-distance Dn is a distance for which the host vehicle VA travels till/until the host vehicle speed Vs is decreased to (becomes equal to) “0 km/h” (i.e., the host vehicle VA completely stops) under the assumption that (assuming that) the host vehicle VA decelerates at the above-described deceleration Gdec.

### (Outline of Operation)

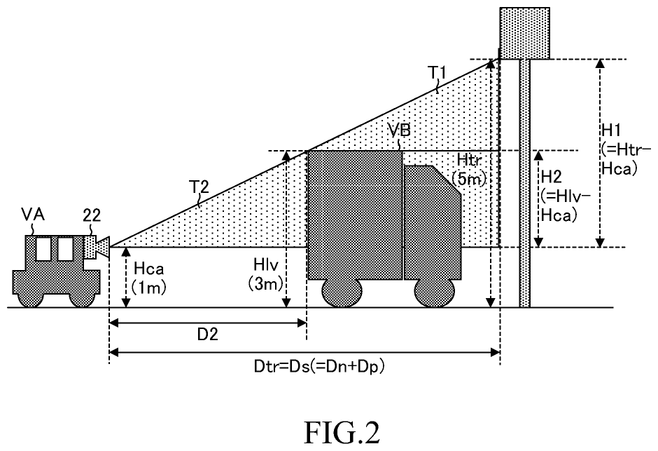

It is assumed that the present assistance apparatus 10 is performing the follow-up cruise control so as to cause the host vehicle 10 to follow a large-size vehicle as the preceding vehicle VB. The large-size vehicle is a vehicle which is likely to have a large-size vehicle height Hlv (refer to FIG. 2) described later, such as a truck and a bus. In this case, the traffic signal equipment (traffic light) TR ahead of the host vehicle VA is hidden by the large-size vehicle. Therefore, when the “traffic-signal-equipment-distance Dtr” is relatively long, the traffic signal equipment TR cannot be photographed (i.e., the image of the traffic signal equipment TR cannot be captured/taken). Thus, a case may arise where the traffic signal equipment TR is photographed for the first time when the “traffic-signal-equipment-distance Dtr” becomes relatively short.

In the above-described case, the “traffic-signal-equipment-distance Dtr” of when the present assistance apparatus 10 starts to successfully detect the traffic signal equipment TR (traffic signal equipment showing a stop signal TR) may be considerably shorter than the start distance Ds. It is highly likely that the host vehicle VA cannot be stopped at (before) the signal equipment TR, if the host vehicle VA starts to and continues to be decelerated at the above-described deceleration Gdec from a time point at which the “traffic-signal-equipment-distance Dtr” is considerably shorter than the start distance Ds. Thus, in this case, it is necessary to decelerate the host vehicle VA at a deceleration having a magnitude greater than a magnitude of the above-described deceleration Gdec (in order to let the host vehicle stop at/before the signal equipment TR). However, decelerating the host vehicle VA at such a great deceleration may cause the passengers of the host vehicle VA to feel uneasy.

In view of the above, when the preceding vehicle VB is a large-size vehicle, the present assistance apparatus 10 obtains a second inter vehicle distance D2. The second inter vehicle distance D2 is a distance that makes the “traffic-signal-equipment-distance Dtr” of when the present assistance apparatus 10 starts to successfully detect (or detects for the first time) a “traffic signal equipment TR having (or whose height is) a predetermined traffic-signal height Htr” be equal to the start distance Ds and be longer than the stop-required-distance Dn, if the inter vehicle distance D between the preceding vehicle VB and the host vehicle VA is kept at the second inter vehicle distance D2. Thereafter, the present assistance apparatus 10 drives the host vehicle VA so as to let the inter vehicle distance D coincide with (become equal to) the second inter vehicle distance D2. The second inter vehicle distance D2 may sometimes be referred to as a “large-size-vehicle inter vehicle distance (or an inter vehicle distance for a large-size vehicle)”.

Accordingly, the present assistance apparatus 10 can stop the host vehicle VA at (before) the “traffic signal equipment showing a stop signal TR” by starting to decelerate the host vehicle VA at the above-described deceleration Gdec at a time point at which the present assistance apparatus 10 successfully detect the “traffic signal equipment showing a stop signal TR” for the first time, without causing the passengers of the host vehicle VA to feel uneasy even when the preceding vehicle VB is the large-size vehicle.

### (Operation)

The above-described second inter vehicle distance D2 is further described in detail with reference to FIG. 2.

The camera height Hca, the large-size vehicle height Hlv, and the traffic-signal height Htr have been fixed (determined in advance) so as to be “1 [m]”, “3 [m]”, and “5 [m]”, respectively. The camera height Hca is a height of the camera device 22, the large-size vehicle height Hlv is a height of the large-size vehicle, and the traffic-signal height Htr is a height of the traffic signal equipment Tr.

As shown in FIG. 2, the right triangle T1 and the “right triangle T2 contained in the right triangle T1” are similar to each other.

The right triangle T1 has a side whose length is equal to the traffic-signal-equipment-distance Dtr, and a side whose length is equal to the height H1 obtained by subtracting the camera height Hca from the traffic-signal height Htr.

The right triangle T2 has a side whose length is equal to the second inter vehicle distance D2, and a side whose length is equal to the height H2 obtained by subtracting the camera height Hca from the large-size vehicle height Hlv.

According to the similarity between the two triangles as noted above, the second inter vehicle distance D2 can be expressed by the following expression (1) using the traffic-signal-equipment-distance Dtr.

$$D 2 = \frac{H 2}{H 1} \times Dtr \qquad ( 1 )$$

A stop-required time T can be expressed by the following expression (2). The stop-required time T is a time (time length) required for the host vehicle speed Vs becomes “0 [km/h] when the host vehicle is decelerated at the deceleration Gdec.

T=Vs/Gdec (2)

A stop-required-distance Dn is a distance for which the host vehicle VA travels when the host vehicle VA is decelerated at the deceleration Gdec for the above-described stop-required time T. The stop-required-distance Dn can be expressed by the following expression (3) using the host vehicle speed Vs observed at a start time point of the deceleration.

$$Dn = \frac{{Vs}^{2}}{2 Gdec} \qquad ( 3 )$$

The second inter vehicle distance D2 can be expressed by the following expression (4) obtained by assigning “a start distance Ds which is a sum of the stop-required-distance Dn and a predetermined distance Dp” to “the traffic-signal-equipment-distance Dtr” in the above-described expression (1).

$$D 2 = \frac{H 2}{H 1} ( \frac{{Vs}^{2}}{2 Gdec} + Dp ) \qquad ( 4 )$$

As understood from the expression (4), since the height H1, the Height H2, the deceleration Gdec, and the predetermined distance Dp are predetermined fixed values, the second inter vehicle distance D2 is expressed by a quadratic function with the host vehicle speed Vs as a variable.

The present assistance apparatus 10 performs the follow-up cruise control to maintain the “inter vehicle distance D to the preceding vehicle VB that is the large-size vehicle VB” at a “distance equal to the above-described second inter vehicle distance D2”. Therefore, the traffic-signal-equipment-distance Dtr of a detection time point at which (or of when) the traffic signal equipment showing a stop signal TR is detected above the preceding vehicle VB for the first time is equal to the start distance Ds. Thus, even when the host vehicle VA starts to be decelerated at the deceleration Gdec from the detection time point by performing a traffic light deceleration control, the host vehicle VA can be stopped at or before the traffic signal equipment showing a stop signal TR.

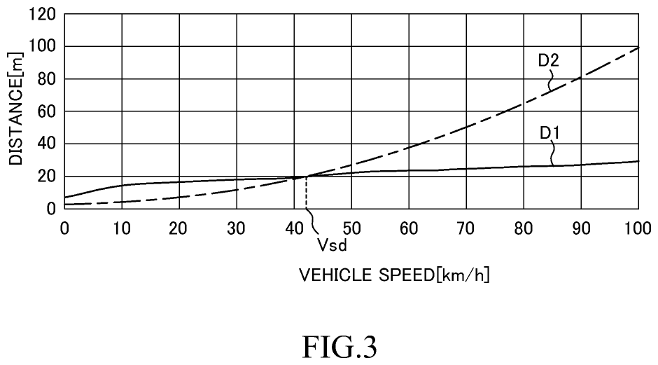

A graph shown in FIG. 3 indicates a relationship between the first inter vehicle distance D1 and the host vehicle speed Vs, and a relationship between the second inter vehicle distance D2 and the host vehicle speed Vs.

The first inter vehicle distance D1 has been set at a value that becomes longer as the host vehicle speed Vs becomes higher within a predetermined range from a set inter vehicle distance Dset (=20 [m])

As expressed by the above-described expression (4), the second inter vehicle distance D2 becomes longer as the host vehicle speed Vs becomes higher in such a manner that the distance D2 varies depending on a square of the host vehicle speed Vs.

Since the stop-required-distance Dn becomes longer as the host vehicle speed Vs becomes longer, the start distance Ds (i.e., the second inter vehicle distance D2) is longer than the first inter vehicle distance D1 when the host vehicle speed Vs is equal to or higher than a predetermined speed Vsd.

The first inter vehicle distance D1 is obtained from a look-up table defining a relationship between the first inter vehicle distance D1 and the host vehicle speed Vs that has been stored in the ROM in advance. The second inter vehicle distance D2 may be obtained from a look-up table defining a relationship between the second inter vehicle distance D2 and the host vehicle speed Vs that has been stored in the ROM in advance. Alternatively, the second inter vehicle distance D2 may be obtained each time by assigning the host vehicle speed Vs to the expression (4).

### (Specific Operation)

### <Acc Routine>

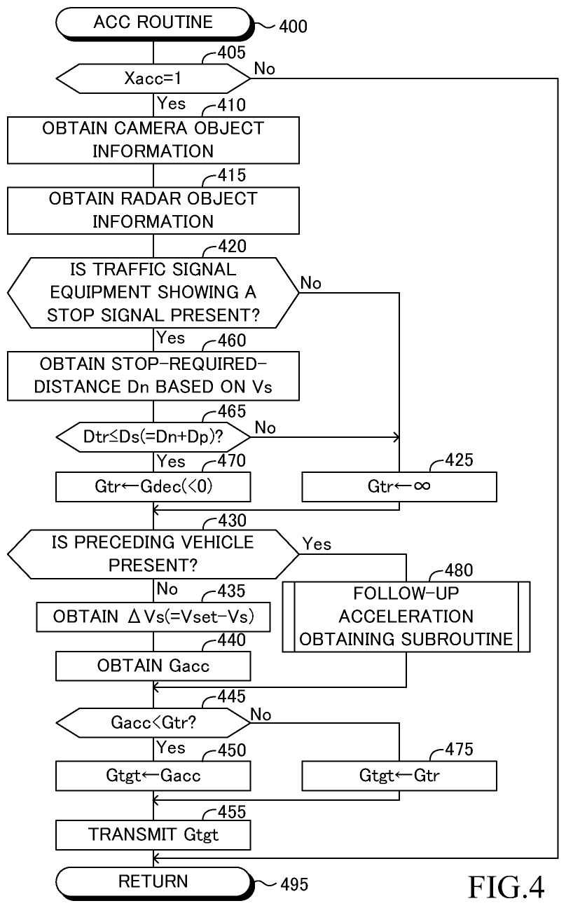

The CPU of the DSECU 20 is configured or programmed to execute an ACC routine shown by a flowchart in FIG. 4 every time a predetermined time elapses. Hereinafter, a “CPU” means the CPU of the DSECU 20, unless otherwise specified.

When an appropriate time point comes, the CPU starts processing from step 400, and proceeds to step 405. At step 405, the CPU determines whether or not a value of an ACC flag Xacc is “1”.

The value of the ACC flag Xacc is set to “1” when a predetermined ACC start condition becomes satisfied, and is set to “0” when a predetermined ACC end condition becomes satisfied. It should be noted that the value of the ACC flag Xacc is set to “0” in an initialization routine. The initialization routine is executed by the CPU when a position of an unillustrated ignition key switch of the host vehicle VA is switched from an off position to an on position.

The ACC start condition is a condition to be satisfied when an unillustrated ACC start switch is operated.

The ACC end condition is a condition to be satisfied when an unillustrated ACC end switch is operated.

When the value of the ACC flag Xacc is “0”, the CPU makes a “No” determination at step 405, and proceeds to step 495 to terminate the present routine tentatively.

When the value of the ACC flag Xacc is “1”, the CPU makes a “Yes” determination at step 405, and sequentially executes the processes of step 410 to step 420.

Step 410: the CPU obtains the camera object information from the camera device 22.

Step 415: the CPU obtains the radar object information from the millimeter wave radar device 23.

Step 420: the CPU determines, based on the camera image, whether or not the traffic signal equipment showing a stop signal TR is present ahead of the host vehicle VA.

When the traffic signal equipment showing a stop signal TR is not present, the CPU makes a “No” determination at step 420, and sequentially executes the processes of step 425 and step 430.

Step 425: the CPU sets the target stop-acceleration Gtr to an infinite value.

Step 430: the CPU determines, based on the camera object information and the radar object information, whether or not the preceding vehicle VB is present.

When the preceding vehicle VB is not present, the CPU makes a “No” determination at step 430, and sequentially executes the processes of step 435 to step 445.

Step 435: the CPU obtains a vehicle speed deviation ΔVs by subtracting the host vehicle speed Vs from the set speed Vset.

Step 440: the CPU obtains the ACC target acceleration Gacc by assigning the vehicle speed deviation ΔVs to the following expression (5).

Gacc=k1·ΔVs (5)

In the above expression (5), k1 is a predetermined gain (coefficient).

Step 445: the CPU determines whether or not the ACC target acceleration Gacc is smaller than the target stop-acceleration Gtr.

As described above, when the traffic signal equipment showing a stop signal TR is not present, the target stop-acceleration Gtr has been set at the infinite value (refer to step 425), and therefore, the ACC target acceleration Gacc is smaller than the target stop-acceleration Gtr. In this case, the CPU makes a “Yes” determination at step 445, and sequentially executes the processes of step 450 and step 455.

Step 450: the CPU sets the target acceleration Gtgt to the ACC target acceleration Gacc.

Step 455: the CPU transmits an acceleration-deceleration instruction including the target acceleration Gtgt to the engine ECU 30 and the brake ECU 40.

Thereafter, the CPU proceeds to step 495 to terminate the present routine tentatively.

When the engine ECU 30 receives the acceleration-deceleration instruction, the engine ECU 30 controls the engine actuator 36 in such a manner that an actual acceleration G of the host vehicle VA becomes equal to the target acceleration Gtgt included in the acceleration-deceleration instruction.

When the brake ECU 40 receives the acceleration-deceleration instruction, the brake ECU 40 controls the brake actuator 44 in such a manner that the actual acceleration G of the host vehicle VA becomes equal to the target acceleration Gtgt included in the acceleration-deceleration instruction.

It should be noted that the actual acceleration G of the host vehicle VA is obtained by differentiating the host vehicle speed Vs with respect to time.

Whereas, in a case where the traffic signal equipment showing a stop signal TR is present when the CPU proceeds to step 420, the CPU makes a “Yes” determination at step 420, and sequentially executes the processes of step 460 and step 465.

Step 460: the CPU obtains the stop-required-distance Dn by assigning the host vehicle speed Vs to the expression (3).

Step 465: the CPU determines whether or not the traffic-signal-equipment-distance Dtr obtained based on the camera image is equal to or shorter than the start distance Ds.

When the traffic-signal-equipment-distance Dtr is longer than the start distance Ds, the CPU makes a “No” determination at step 465, and sets the target stop-acceleration Gtr to the infinite value at step 425. Thereafter, the CPU proceeds to the steps following step 430.

Whereas, when the traffic-signal-equipment-distance Dtr is equal to or shorter than the start distance Ds, the CPU makes a “Yes” determination at step 465, and proceeds to step 470. At step 470, the CPU sets the target stop-acceleration Gtr to the above-described deceleration Gdec, and proceeds to step 430.

When the preceding vehicle VB is not present, the CPU makes a “No” determination at step 430, and sequentially executes the processes of step 435 and step 440 so as to obtain the ACC target acceleration Gacc. When the ACC target acceleration Gacc is equal to or greater than the target stop-acceleration Gtr (namely, when the target stop-acceleration Gtr is equal to or smaller than the ACC target acceleration Gacc), the CPU makes a “No” determination at step 445 so as to proceed to step 475. At step 475, the CPU sets the target acceleration Gtgt to the target stop-acceleration Gtr. Thereafter, the CPU proceeds to step 455 so as to transmit the acceleration-deceleration instruction, and proceeds to step 495 to terminate the present routine tentatively.

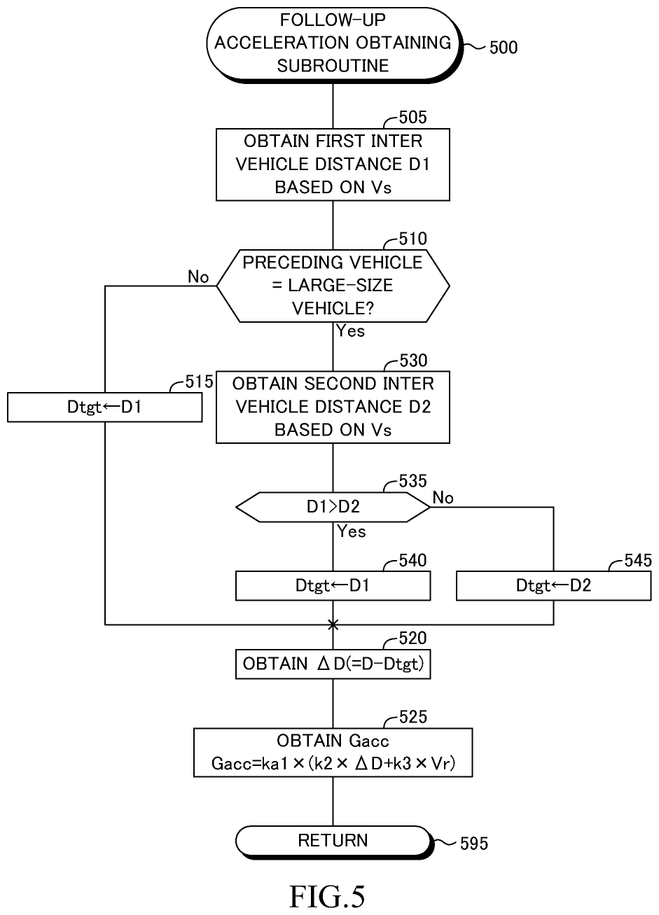

In contrast, in a case where the preceding vehicle VB is present when the CPU proceeds to step 430, the CPU makes a “Yes” determination at step 430, and proceeds to step 480. At step 480, the CPU executes a follow-up acceleration obtaining subroutine shown by a flowchart in FIG. 5. In the follow-up acceleration obtaining subroutine, the CPU obtains the target acceleration Gtgt that causes the target inter vehicle distance Dtgt to be/become equal to either the first inter vehicle distance D1 or the second inter vehicle distance D2. After the CPU executes the follow-up acceleration obtaining subroutine at step 480, the CPU proceeds to steps following step 445.

### <Follow-Up Acceleration Obtaining Subroutine>

When the CPU proceeds to step 480 shown in FIG. 4, the CPU starts processing from step 500 shown in FIG. 5, and sequentially executes the processes of step 505 and step 510.

Step 505: the CPU obtains the first inter vehicle distance D1 by applying the host vehicle speed Vs to the lookup table defining the relationship between the first inter vehicle distance D1 and the host vehicle speed Vs.

Step 510: the CPU determines whether or not the preceding vehicle VB is a large-size vehicle, based on the camera image.

More specifically, the CPU is configured to determine that the preceding vehicle VB is the large-size vehicle, when a ratio (i.e., an aspect ratio) is equal to or greater than a threshold value. The aspect ratio is a ratio of the number of pixels of the camera image indicating the preceding vehicle VB in a vertical direction to the number of pixels of the camera image indicating the preceding vehicle VB in a horizontal direction. It should be noted that at least one image (recorded image) representing a large-size vehicle may have been stored in the ROM, and the CPU may be configured to obtain a degree of similarity between the image of the preceding vehicle VB in the camera image and the recorded image, and to determine that the preceding vehicle VB is the large-size vehicle when the obtained degree of similarity is equal to or greater than a threshold value.

When the preceding vehicle VB is not the large-size vehicle, the CPU makes a “No” determination at step 510, and sequentially executes the processes of step 515 to step 525.

Step 515: the CPU sets the target inter vehicle distance Dtgt to the first inter vehicle distance D1.

Step 520: the CPU obtains a distance deviation ΔD by subtracting the target inter vehicle distance Dtgt from the inter vehicle distance D.

Step 525: the CPU obtains the ACC target acceleration Gacc by assigning the distance deviation ΔD and the object relative speed Vr to the following expression (6).

Gacc=Ka1·(k2·ΔD+k3·Vr) (6)

In the above expression (6), each of ka1, k2, and k3 is a predetermined gain (coefficient).

Thereafter, the CPU proceeds to step 595 to terminate the present routine tentatively, and proceeds to step 445 shown in FIG. 4.

Whereas, if it is determined that the preceding vehicle VB is the large-size vehicle when the CPU proceeds to step 510, the CPU makes a “Yes” determination at step 510, and sequentially executes the processes of step 530 and step 535.

Step 530: the CPU obtains the second inter vehicle distance D2 by applying the host vehicle speed Vs to the above-described expression (4).

Step 535: the CPU determines whether or not the first inter vehicle distance D1 is greater than the second inter vehicle distance D2.

When the first inter vehicle distance D1 is greater than the second inter vehicle distance D2, the CPU makes a “Yes” determination at step 535, and proceeds to step 540. At step 540, the CPU sets the target inter vehicle distance Dtgt to the first inter vehicle distance D1.

Whereas, when the first inter vehicle distance D1 is equal to or smaller than the second inter vehicle distance D2, the CPU makes a “No” determination at step 535, and proceeds to step 545. At step 545, the CPU sets the target inter vehicle distance Dtgt to the second inter vehicle distance D2.

After the CPU executes the process at either step 540 or step 545, the CPU executes the processes of step 520 and step 525 so as to obtain the ACC target acceleration Gacc. Thereafter, the CPU proceeds to step 595 to terminate the present routine tentatively, and proceeds to step 445 shown in FIG. 4.

According to the present embodiment, when the preceding vehicle VB is the large-size vehicle, the host vehicle VA is driven in such a manner that the inter vehicle distance D is caused to become equal to (coincide with) either the first inter vehicle distance D1 or the second inter vehicle distance D2 expressed by the above-described expression (4), whichever is longer. This can cause the “traffic-signal-equipment-distance Dtr” of when the traffic signal equipment showing a stop signal TR is detected above the large-size vehicle serving as the preceding vehicle VB for the first time to be equal to or longer than the start distance Ds. Therefore, the host vehicle VA can be stopped at or before the traffic signal equipment showing a stop signal TR without being decelerated at a great deceleration (i.e., without decreasing the host vehicle speed Vs rapidly).

The present disclosure should not be limited to the above-described embodiment, and may employ various modifications within the scope of the present disclosure.

### (First Modification)

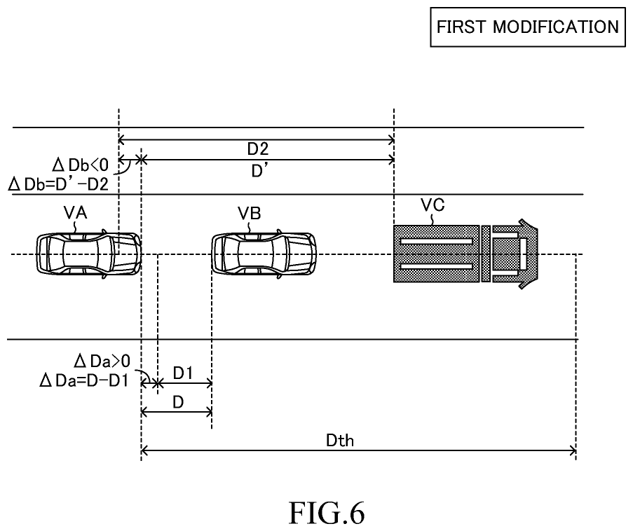

Outline of operations of the first modification will next be described with reference to FIG. 6.

Even if the preceding vehicle VB is not a large-size vehicle, the DSECU 20 of the first modification obtains the first inter vehicle distance D1 and the second inter vehicle distance D2, when a large-size vehicle is present within a predetermine distance Dth from the front end of the host vehicle VA. In an example shown in FIG. 6, it is assumed that a preceding-preceding vehicle VC that is a vehicle traveling ahead of the preceding vehicle VB is a large-size vehicle. The DSECU 20 obtains a first distance deviation ΔDa by subtracting the first inter vehicle distance D1 from the inter vehicle distance D between the host vehicle VA and the preceding vehicle VB, and obtains a second distance deviation Δdb by subtracting the second inter vehicle distance D2 from the inter vehicle distance D′ between the host vehicle VA and the preceding-preceding vehicle VC. The DSECU 20 sets the target inter vehicle distance Dtgt to the first inter vehicle distance D1 when the first distance deviation ΔDa is smaller than the second distance deviation Δdb. Whereas, the DSECU 20 sets the target inter vehicle distance Dtgt to the second inter vehicle distance D2 when the first distance deviation ΔDa is equal to or larger than the second distance deviation Δdb.

In the example shown in FIG. 6, the inter vehicle distance D is longer than the first inter vehicle distance D1, and thus, the first distance deviation ΔDa is a positive value. Whereas, the inter vehicle distance D′ is shorter than the second inter vehicle distance D2, and thus, the second distance deviation Δdb is a negative value. Therefore, since the first distance deviation ΔDa is greater than the second distance deviation Δdb, the DSECU 20 sets the target inter vehicle distance Dtgt to the second inter vehicle distance D2.

In a case where the preceding vehicle is not a large-size vehicle, but a large-size vehicle is present within the predetermined distance Dth from the host vehicle VA, there is a possibility that the DSECU 20 cannot detect the traffic signal equipment TR due to that large-size vehicle when/while the traffic-signal-equipment-distance Dtr is relatively long. Even in this case, the first modification can cause the “traffic-signal-equipment-distance Dtr” of when the traffic signal equipment showing a stop signal TR is detected for the first time to be equal to or longer than the start distance Ds. Therefore, when the host vehicle VA is decelerated at the above-described deceleration Gdec, the host vehicle VA can be stopped at or before the traffic signal equipment showing a stop signal TR.

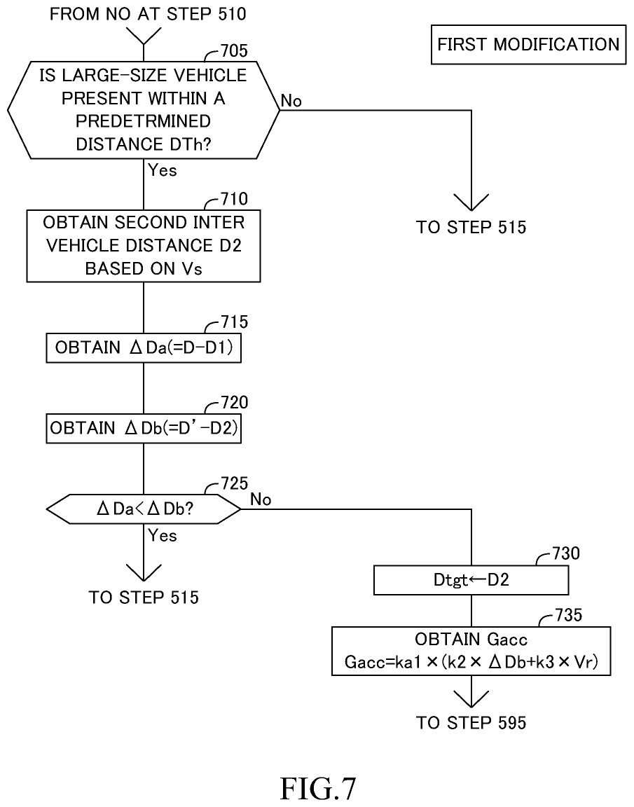

The CPU of the DSECU 20 according to the first modification proceeds to step 705 shown in FIG. 7, when the CPU makes a “No” determination at 510 (i.e., when the preceding vehicle VB is not a large-size vehicle). At step 705, the CPU determines whether or not a large-size vehicle is present within the predetermined distance Dth in a frontward direction from the front end of the host vehicle VA.

When such a large-size vehicle is not present within the predetermined distance Dth, the CPU makes a “No” determination at 705, and proceeds to step 515 shown in FIG. 5. At step 515, the CPU sets the target inter vehicle distance Dtgt to the first inter vehicle distance D1. Thereafter, the CPU sequentially executes the processes of step 520 and step 525, shown in FIG. 5.

Whereas, when a large-size vehicle is present within the predetermined distance Dth, the CPU makes a “Yes” determination at 705 shown in FIG. 7, and sequentially executes the processes of step 710 to step 725.

Step 710: the CPU obtains the second inter vehicle distance D2 by applying the host vehicle speed Vs to the above-described expression (4).

Step 715: the CPU obtains the first distance deviation ΔDa by subtracting the first inter vehicle distance D1 from the inter vehicle distance D.

Step 720: the CPU obtains the second distance deviation Δdb by subtracting the second inter vehicle distance D2 from the inter vehicle distance D′.

Step 725: the CPU determines whether or not the first distance deviation ΔDa is smaller than the second distance deviation Δdb.

When the first distance deviation ΔDa is smaller than the second distance deviation Δdb, the CPU makes a “Yes” determination at step 725, and proceeds to step 515 shown in FIG. 5 so as to set the target inter vehicle distance Dtgt to the first inter vehicle distance D1. Thereafter, the CPU sequentially executes the processes of step 520 and step 525, shown in FIG. 5.

Whereas, when the first distance deviation ΔDa is equal to or greater than the second distance deviation Δdb, the CPU makes a “No” determination at step 725, and sequentially executes the processes of step 730 and step 735.

Step 730: the CPU sets the target inter vehicle distance Dtgt to the second inter vehicle distance D2.

Step 735: the CPU obtains the ACC target acceleration Gacc by assigning the above-described second distance deviation Δdb and the object relative speed Vr to the following an expression (7).

Gacc=Ka1·(k2·Δdb+k3·Vr) (7)

The expression (7) is different from the above expression (6) in that second distance deviation Δdb is used in place of the distance deviation ΔD.

The CPU executes the process of step 735, and proceeds to step 595 shown in FIG. 5 so as to terminate the present routine tentatively. Thereafter, the CPU proceeds to step 445 shown in FIG. 4.

### (Second Modification)

In the above-described embodiment, the DSECU 20 sets the target stop-acceleration Gtr to the predetermined deceleration Gdec, when the traffic-signal-equipment-distance Dtr to the traffic signal equipment showing a stop signal TR is equal to or shorter than the start distance Ds. Whereas, in the second modification, the DSECU 20 obtains an acceleration required for the host vehicle VA to stop at a position that is a predetermined distance before the traffic signal equipment showing a stop signal TR, and sets the target stop-acceleration Gtr to the obtained acceleration.

Even if the target stop-acceleration Gtr is obtained as in the second modification, the host vehicle VA can be stopped before the traffic signal equipment showing a stop signal TR without being decelerated at a large deceleration, since the host vehicle VA is traveling while keeping the inter vehicle distance D that causes the traffic-signal-equipment-distance Dtr of when the traffic signal equipment showing a stop signal TR is detected for the first time to be equal to or longer than the start distance Ds.

### (Third Modification)

In the above-described embodiment, the CPU is configured to determine, based on the camera image, whether or not a vehicle other than the host vehicle is a large-size vehicle, however, the CPU may use information other than the camera image when determining whether or not a vehicle other than the host vehicle is a large-size vehicle. One example will next be described.

The host vehicle VA may be configured to obtain information that is used for determining whether or not a vehicle (particular vehicle) other than the host vehicle is a large-size vehicle thorough communicating with that particular vehicle present within a range of radio communication.

For example, the above-described information is type-of-vehicle information indicative of a type of the particular vehicle. In the ROM of the DSECU 20, type-of-vehicle information indicative of a large-size vehicle has been stored. The CPU of the DSECU 20 obtains, thorough inter vehicle communication, the type-of-vehicle information of the particular vehicle. The CPU determines that the particular vehicle is a large-size vehicle when the obtained type-of-vehicle information is the same as the stored type of vehicle information indicative of a large-size vehicle.

### (Fourth Modification)

The millimeter wave radar device 23 may be replaced with a remote sensing device configured to be able to detect an object by transmitting a radio wave in place of the millimeter wave and receiving a radio wave that is reflected by the object.

### (Fifth Modification)

The present assistance apparatus 10 can be applied not only to the above-described conventional vehicle having the internal combustion engine, but also to one of a Hybrid Electric Vehicle, a Plug-in Hybrid Electric Vehicle, a Fuel Cell Electric Vehicle, and a Battery Electric Vehicle.

The present disclosure may be viewed as a machine readable and nonvolatile storage medium storing programs that realize the functions of the above-described present assistance apparatus 10.

What is claimed is:

1. A driving assistance apparatus comprising:
a camera device configured to obtain a camera image by taking a picture of a predetermined area ahead of a host vehicle; and
a control unit configured to drive said host vehicle so as to cause an acceleration of said host vehicle to become equal to a follow-up acceleration to make an inter vehicle distance between a preceding vehicle traveling ahead of said host vehicle and said host vehicle coincide with a target inter vehicle distance;
wherein,
said control unit is configured to set said target inter vehicle distance to a large-size-vehicle inter vehicle distance when said preceding vehicle is a large-size vehicle, said large-size-vehicle inter vehicle distance for causing a traffic-signal-equipment-distance indicative of a distance to a traffic signal equipment having a predetermined height of a detection time point at which said traffic signal equipment is detected above said preceding vehicle in said camera image to be longer than a stop-required-distance indicative of a distance for which said host vehicle travels until said host vehicle stops assuming that said host vehicle starts decelerating at a predetermined deceleration from said detection time point

2. The driving assistance apparatus according to claim 1,
wherein,
said control unit is configured to obtain said target inter vehicle distance, in such a manner that said target inter vehicle distance for a case where said preceding vehicle is a large-size vehicle is longer than said target inter vehicle distance for a case where said preceding vehicle is not a large-size vehicle, when a host vehicle speed indicative of a speed of said host vehicle is equal to or higher than a predetermined speed.

3. The driving assistance apparatus according to claim 2,
wherein,
said control unit is configured to:
set, when said preceding vehicle is not a large-size vehicle, said target inter vehicle distance to an ordinary inter vehicle distance that is longer within a predetermined range from a preset inter vehicle distance as said host vehicle speed is higher; and
set, when said preceding vehicle is a large-size vehicle, said target inter vehicle distance to either said ordinary inter vehicle distance or said large-size vehicle inter vehicle distance, whichever is longer.

4. The driving assistance apparatus according to claim 1,
wherein,
said control unit is configured to obtain said large-size vehicle inter vehicle distance in such a manner that said large-size vehicle inter vehicle distance is equal to or longer than a distance obtained by multiplying said stop-required-distance by a preset constant.

5. The driving assistance apparatus according to claim 4,
wherein,
said preset constant has been set at a value obtained by dividing a first value by a second value, wherein said first value is a value obtained by subtracting a preset camera height indicative of a height of said camera device from a preset large-size vehicle height indicative of a height of said large-size vehicle, and said second value is a value obtained by subtracting said camera height from a preset traffic-signal height indicative of a height of said traffic signal equipment.

6. The driving assistance apparatus according to claim 4,
wherein,
said control unit is configured to obtain said large-size vehicle inter vehicle distance in such a manner that said large-size vehicle inter vehicle distance varies depending on a square of a host vehicle speed indicative of a speed of said host vehicle so that said large-size vehicle inter vehicle distance becomes longer as said host vehicle speed becomes higher.

7. The driving assistance apparatus according to claim 1,
wherein,
said control unit is configured to drive said host vehicle so as to make an acceleration of said host vehicle coincide with either said follow-up acceleration or a deceleration that causes said host vehicle to stop before said traffic signal equipment, whichever is smaller, when said traffic-signal-equipment-distance becomes equal to or shorter than a start distance that is a sum of said stop-required-distance and a predetermined distance while said traffic signal equipment is showing a stop signal.

8. The driving assistance apparatus according to claim 1,
wherein,
said control unit is configured to:
when said preceding vehicle is not said large-size vehicle,
obtain, as said target inter vehicle distance, an ordinary inter vehicle distance that becomes longer as a host vehicle speed indicative of a speed of said host vehicle becomes higher within a predetermined range from a preset inter vehicle distance; and
when a vehicle, that is other than said preceding vehicle, that is present within a predetermined distance in a forward direction from said host vehicle is said large-size vehicle,
obtain said ordinary inter vehicle distance and said large-size-vehicle inter vehicle distance;
set said target inter vehicle distance to said ordinary inter vehicle distance, when a first distance deviation is smaller than a second distance deviation, wherein said first distance deviation is a value obtained by subtracting said ordinary inter vehicle distance from said inter vehicle distance, and said second distance deviation is a value obtained by subtracting said large-size-vehicle inter vehicle distance from an inter vehicle distance between said large-size vehicle and said host vehicle; and
set said target inter vehicle distance to said large-size-vehicle inter vehicle distance, when said first distance deviation is equal to or greater than said second distance deviation.

9. A vehicle in which the driving assistance apparatus according to claim 1 is installed.

10. A driving control method for driving a host vehicle in such a manner that an acceleration of said host vehicle is caused to become equal to a follow-up acceleration to make an inter vehicle distance between a preceding vehicle traveling ahead of said host vehicle and said host vehicle coincide with a target inter vehicle distance, comprising:
a first step for setting said target inter vehicle distance to a large-size-vehicle inter vehicle distance when said preceding vehicle is a large-size vehicle, said large-size-vehicle inter vehicle distance for causing a traffic-signal-equipment-distance indicative of a distance to a traffic signal equipment having a predetermined height of a detection time point at which said traffic signal equipment is detected above said preceding vehicle in a camera image obtained by a camera device mounted on said host vehicle by taking a picture of a predetermined area ahead of said host vehicle to be longer than a stop-required-distance indicative of a distance for which said host vehicle travels until said host vehicle stops assuming that said host vehicle starts decelerating at a predetermined deceleration from said detection time point; and
a second step for driving said host vehicle in such a manner that said acceleration of said host vehicle coincides with said follow-up acceleration.

11. A program storage device, readable by machine, storing a program for driving a host vehicle in such a manner that an acceleration of said host vehicle is caused to become equal to a follow-up acceleration to make an inter vehicle distance between a preceding vehicle traveling ahead of said host vehicle and said host vehicle coincide with a target inter vehicle distance,
said program causing a processor to implement processes of:
a first step for setting said target inter vehicle distance to a large-size-vehicle inter vehicle distance when said preceding vehicle is a large-size vehicle, said large-size-vehicle inter vehicle distance for causing a traffic-signal-equipment-distance indicative of a distance to a traffic signal equipment having a predetermined height of a detection time point at which said traffic signal equipment is detected above said preceding vehicle in a camera image obtained by a camera device mounted on said host vehicle by taking a picture of a predetermined area ahead of said host vehicle to be longer than a stop-required-distance indicative of a distance for which said host vehicle travels until said host vehicle stops assuming that said host vehicle starts decelerating at a predetermined deceleration from said detection time point; and
a second step for driving said host vehicle in such a manner that said acceleration of said host vehicle coincides with said follow-up acceleration.
